(19) United States
(12) Patent Application Publication
(10) Pub. No.: US 2026/0367966 A1
(43) Pub. Date: Nov. 19, 2026

(54) MULTI-AGENTIC FRAMEWORK FOR ADAPTING LARGE LANGUAGE MODELS

(71) Applicant: Qualtrics, LLC, Provo, UT (US)

(72) Inventors: Kalyan Basu, Sammamish, WA (US); Quinn Underwood, Seattle, WA (US); Zhongwei Wu, Seattle, WA (US); Wojtek Kubik, Seattle, WA (US); Amol Kelkar, Redmond, WA (US); Paul Mayfield, Salt Lake City, UT (US)

(21) Appl. No.: 19/208,413

(22) Filed: May 14, 2025

(51) Int. Cl. G06F 9/48; G06F 18/2415

(52) U.S. Cl. CPC G06F 9/4881; G06F 18/2415

(57) ABSTRACT

One or more embodiments described herein include a composite agentic system that uses a centrally hosted multi-agent processing framework architecture that leverages artificial intelligence models to accomplish tasks to create personalized experiences throughout a user's product or service journey across multiple domains. Indeed, the composite agentic system hosts and coordinates a multi-agent processing framework that receives a user query, extracts discrete processing tasks from the user query, and determines one or more agentic subsystems from respective agentic subsystems to generate a processing framework output from the discrete processing tasks.

### BACKGROUND

Recent years have seen considerable advances in hardware and software platforms designed to deliver personalized user account experiences. For example, many traditional systems collect user account data from digital surveys, client devices, and other sources and leverage these data to target user interfaces and responses for user accounts. Additionally, some traditional systems analyze user account interactions with digital content to infer or predict user account preferences. While capable in some respects, these systems nevertheless exhibit numerous technical shortcomings that hinder their ability to seamlessly provide personalized experiences, particularly when it comes to augmenting responses or outputs for user accounts.

One limitation faced by conventional systems is inaccuracy when performing tasks for a user account. Indeed, while conventional systems implement artificial intelligence agents to autonomously execute tasks, some such systems predominantly rely on existing large language models (with billions of parameters) that are trained using enormous amounts of data across myriad topics or domains. Such overgeneralized training often results in generating results, and executing tasks, that are generic in nature, and which inaccurately focus (or which entirely lack focus) on domain-specific data or user-account specific data. Such generalized training also frequently results in hallucinations, where an artificial intelligence agent mistakenly treats false responses or improperly executed tasks as true or proper.

Further, conventional systems are operationally inflexible. Specifically, conventional systems rely on rigid, pretrained model architectures to generate results and/or to execute tasks. For example, many existing systems use artificial intelligence agents to determine and execute computer processes, but the rigid architecture of existing models prevents them from adapting to domain-specific data, instead relying on the broad general nature of conventional large language model training. As a result, conventional systems often generate results and/or execute tasks that are too general and not well tailored to domain-specific data (e.g., relating to specific entities, tasks, companies) or to user account data. At best, conventional systems use broadly trained models to generate generic responses to queries.

Due at least in part to their inaccuracy and inflexibility, conventional systems are also inefficient. Specifically, many conventional systems require an excessive number of interactions to generate results and/or execute tasks. For instance, because existing systems use simplistic pipelines (e.g., consisting of a single general-purpose large language model) to feed complex queries to overgeneralized models that generate generic results. Such systems require additional user interactions to interact with models (e.g., large language models) by providing additional queries with more information and further instruction to continue to specify over multiple turns or iterations.

Adding to these inefficiencies, some conventional systems require interacting with different artificial intelligence agents for different domains or different tasks, even when the tasks are part of the same overarching goal (e.g., one for booking flights, one for booking hotels, and one for renting cars). In some cases, each of these domains or tasks has its own application, website, and/or interface. Interacting with each of the different agents in their respective software environments becomes navigationally expensive in terms of numbers of user interactions, requiring navigation among many interfaces and applications to accomplish the respective tasks. Processing the excessive interactions that result from such compartmentalized prior systems, as well as those that result from excessive back-and-forth communication informing the models, further results in consuming excessive computational resources (e.g., processing power and memory) that could otherwise be preserved with a more efficient system. Such resource expenditure is further compounded when considering the processing and memory requirements for running the multiple separate applications for each of the task-specific models, often simultaneously.

### SUMMARY

Embodiments of the present disclosure provide benefits and/or solve one or more of the foregoing or other problems in the art with systems, non-transitory computer-readable media, and methods that facilitate generation of responses and/or execution of tasks a multi-agent processing framework to adapt fine-tuned large language models according to user account preferences. For example, the disclosed systems can use an orchestrator layer of a multi-agent processing framework to extract discrete processing tasks from a user query and assign the discrete processing tasks to a plurality of agentic subsystems. The disclosed systems can further use an agent-to-agent communication protocol to further orchestrate completion of the tasks by generating agent payloads that contain augmented instructions for the fine-tuned large language models. Further, based on generating the agent payloads, the disclosed systems can generate a processing framework output that can include adapted instructions for the fine-tuned large language models and/or an update to provide to a user account regarding a user query.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates an overview of the composite agentic system utilizing a multi-agent processing framework to generate a processing framework output in response to receiving a user query in accordance with one or more embodiments.

FIG. 2 illustrates an overview diagram of a multi-agent processing framework utilized by the composite agentic system to generate a processing framework output in accordance with one or more embodiments.

FIG. 3 illustrates an overview of the agentic subsystems the composite agentic system orchestrates in accordance with one or more embodiments.

FIG. 4 illustrates an overview of the composite agentic system using agentic subsystems to autonomously identify a data item of a plurality of data items to surface to a user account in accordance with one or more embodiments.

FIG. 5 illustrates an overview of the composite agentic system using an orchestrator model to extract discrete processing tasks from a user query and assigning processing tasks to respective agentic subsystems in accordance with one or more embodiments.

FIG. 6 illustrates an overview of the composite agentic system providing a processing framework output of a multi-agent processing framework to an additional multi-agent processing framework to cause the additional multi-agent processing framework to generate an additional processing framework output according to the processing framework output.

FIG. 7 illustrates an example environment in which a composite agentic system operates in accordance with one or more embodiments.

FIG. 8 illustrates an example flowchart of a series of acts for utilizing fine-tuned large language models (LLMs) of a large language model to augment task performance in accordance with one or more embodiments.

FIG. 9 illustrates a block diagram of an exemplary computing device in accordance with one or more embodiments.

FIG. 10 illustrates a network environment of the experience delivery system in accordance with one or more embodiments.

### DETAILED DESCRIPTION

One or more embodiments described herein include or refer to a composite agentic system that uses a centrally hosted multi-agent processing framework that leverages artificial intelligence models (e.g., large language models or “LLMs”) to accomplish inter-platform and cross-platform tasks to create personalized experiences throughout a user's product or service journey. Indeed, the composite agentic system hosts, organizes, and coordinates a multi-agent processing framework that receives user queries (e.g., from client device inputs or statuses received via a user interface of a client device), creates tasks from the user queries (e.g., by dissecting a query into multiple, independently executable subcomponents), and interfaces with large language models augmented via fine-tuned LLMs to perform tasks.

As a general overview, the composite agentic system can utilize a multi-agent processing framework to receive the user queries and orchestrate discrete processing tasks from the user queries. As described in further detail below, the multi-agent processing framework can include or be made up of a stratified structure of sub-systems, an orchestrator model, respective agentic subsystems, and multiple fine-tuned large language models which the composite agentic system adapts to provide knowledge to the agentic subsystems.

Specifically, the composite agentic system can utilize an orchestrator model of the multi-agent processing framework to parse a user query to extract discrete processing tasks from the user query. For instance, the composite agentic system can utilize the orchestrator model to determine that a user query describes or conveys a multi-part function or goal which is separable into sub-functions or tasks. Accordingly, the composite agentic system can extract a series of discrete processing tasks (which are discrete sub-parts, functions, or subroutines of the overall query) from the user query, some of which are implicitly, rather than explicitly, contained or described in the user query. Further, the composite agentic system can use an agent-to-agent communication protocol to determine which specific agentic subsystems of the multi-agent processing framework to assign which discrete processing tasks. Further, the composite agentic system can use the multi-agent processing framework to generate a processing framework output that relates to the user query. Additionally, in some embodiments, the composite agentic system can use the agent-to-agent communication protocol to autonomously determine and perform augmenting tasks related to the discrete processing tasks or to otherwise augment a processing framework output.

For example, the composite agentic system can receive a user query requesting purchase of ingredients to bake a cake. The composite agentic system can use the orchestrator model to decompose or otherwise process the user query to extract discrete processing tasks from the user query by determining that generating recommendations for baking a cake is a multi-part function achieved through execution of multiple functions, tasks, or processes. Using the orchestrator model, the composite agentic system thus extracts a first task of accessing sources for determining any dietary restrictions for a user account (e.g., the user account that the composite agentic system receives the user query from), a second task of determining cake preferences for the user account, a third task of determining a cake recipe according to the cake preferences and the dietary restrictions, a fourth task of determining ingredients for the cake recipe indicated by the recipe, a fifth task of determining a desired (e.g., pre-selected, preferred, or nearest) grocery store that has the ingredients of the recipe in stock, and a sixth task of ordering the ingredients for the grocery store for the recipe. The composite agentic system can further use the orchestrator model to determine appropriate agentic subsystems to provide the tasks to in order to enable the agentic subsystems to augment and/or complete the tasks.

Further, based on receiving the user query and determining the discrete processing tasks, the composite agentic system can use one or more agentic subsystems to passively monitor data streams on the client device. Through such monitoring, the composite agentic system can extract a plurality of data items related to the user query and can autonomously determine to surface one or more of the data items to the client device. For example, based on identifying the cake preferences, the cake recipe, the ingredients, and/or the grocery store, the composite agentic system can passively monitor data streams related to the discrete processing tasks to surface relevant data items (e.g., such as a sale on ingredients used in the cake recipe, a new cake recipe that the composite agentic system determines aligns with the preferences of the user account, a recall on one or more ingredients for the recipe, and/or a change in a status of an ingredient at a grocery store, etc.).

In some embodiments, the composite agentic system can generate the processing framework output to be an indication for a fine-tuned large language model to generate an instruction for an entity-specific agent to enable the entity-specific agent to complete a discrete processing task of the discrete processing tasks. In some embodiments, the composite agentic system can generate the processing framework output to be a notification related to the user query to provide to the client device.

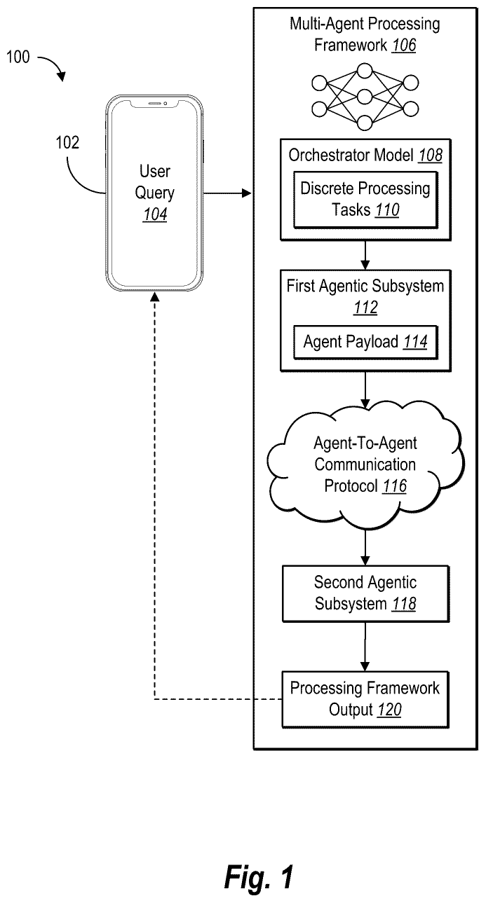

Additional detail will be provided with reference to the figures. For example, FIG. 1 illustrates an example overview of the composite agentic system using a multi-agent processing framework to dissect a user query to determine discrete processing tasks to provide to respective agentic subsystems in accordance with one or more embodiments. Additional detail regarding the acts and processes introduced in relation to FIG. 1 is provided below with reference to subsequent figures.

As shown in FIG. 1, a composite agentic system 100 can receive a user query 104 from a client device 102. The client device 102 can be associated with a user account. The user query 104 can be a query or an instruction or a request to generate an output or to accomplish an overall objective. Further, the composite agentic system 100 can receive the user query 104 through a plurality of modalities. For example, user query 104 can be a text input or audio input. In some embodiments, the composite agentic system 100 can receive the user query 104 through a user interface and/or through a microphone.

As illustrated in FIG. 1, the composite agentic system 100 can provide the user query 104 to a multi-agent processing framework 106. As shown, the multi-agent processing framework 106 can include an orchestrator model 108 and respective agentic subsystems, such as a first agentic subsystem 112 and a second agentic subsystem 118. As illustrated, the composite agentic system 100 can use an agent-to-agent communication protocol 116 to facilitate communication between the first agentic subsystem 112 and the second agentic subsystem 118.

As illustrated, the composite agentic system 100 can use the orchestrator model 108 to extract or otherwise determine discrete processing tasks 110 from the user query 104. Further, the composite agentic system 100 can use the orchestrator model 108 to identify or otherwise determine a first processing task from the discrete processing tasks 110. Based on determining the first processing task from the discrete processing tasks 110, the composite agentic system 100 can determine the first agentic subsystem 112 from among a plurality or respective agentic subsystems. Further, the composite agentic system 100 can provide the first processing task to the first agentic subsystem 112.

Based on providing the first processing task to the first agentic subsystem 112, the composite agentic system 100 can use the first agentic subsystem 112 to execute the first processing task to generate an agent payload 114. For example, the composite agentic system 100 can generate the agent payload 114 to augment the user query 104. For example, the composite agentic system 100 can generate the agent payload 114 to be a suggestion for the user account that relates to the user query 104. In some embodiments, the agent payload 114 can be an instruction enabling a large language model to perform a task for the user account.

As illustrated in FIG. 1, based on generating the agent payload 114, the composite agentic system 100 can utilize the agent-to-agent communication protocol 116 to identify the second agentic subsystem 118 from among the plurality of respective agentic subsystems. In some embodiments, the composite agentic system 100 can use the agent-to-agent communication protocol 116 to determine the second agentic subsystem 118 in conjunction with the orchestrator model 108. In response to identifying the second agentic subsystem 118, the composite agentic system 100 can use the agent-to-agent communication protocol 116 to provide the agent payload 114 to the second agentic subsystem 118.

As shown, the composite agentic system 100 can use the second agentic subsystem 118 to generate a processing framework output 120. Specifically, the composite agentic system 100 can use the second agentic subsystem 118 to process the agent payload 114 to generate the processing framework output 120. For example, where the composite agentic system 100 generates the agent payload 114 to be a suggestion to the user account, the composite agentic system 100 can use the agent-to-agent communication protocol 116 to identify the second agentic subsystem 118 to generate the processing framework output 120 by augmenting the suggestion to the user account. In some embodiments, where the composite agentic system 100 generates the agent payload 114 to be an instruction for a large language model (e.g., an LLM) to enable the large language model to complete the first processing task and generates the processing framework output 120 to indicate completion of the first processing task. In some embodiments, the composite agentic system 100 can generate the processing framework output 120 to include the instruction to enable the large language model to complete the first processing task and a status update corresponding to the instruction, and the composite agentic system 100 can provide the status update to the client device 102.

As previously mentioned, embodiments of the composite agentic system 100 provide several advantages over conventional systems. For instance, the composite agentic system 100 solves the technologically rooted problem of utilizing agentic models and/or large language models to accurately perform discrete processing tasks for user accounts. Indeed, the composite agentic system 100 uses a multi-agent processing framework to generate personalized, augmented prompts for fine-tuned large language models by utilizing agentic subsystems of a multi-agent processing framework to refine and augment prompts by generating agent payloads for executing discrete functions that make up a multi-order, cross-agent query.

To accomplish this, the composite agentic system 100 facilitates generating augmented prompts for fine-tuned large language models by using an agent-to-agent communication protocol that facilitates cross-communication among agentic subsystems. Further, the composite agentic system 100 generates fine-tuned large language models utilizing domain-specific data (e.g., data specific to an entity within an industry). Accordingly, through the multi-agent processing framework and the fine-tuned LLMs, the composite agentic system 100 utilizes multiple purpose-driven large language models across various agents to provide highly tailored, specific answers. Through the purpose-driven and task-specific LLMs described, the composite agentic system 100 reduces the generalization of conventional large language models, thereby improving accuracy and reducing hallucinations in task execution.

Moreover, the composite agentic system 100 increases in operational flexibility over conventional systems. For example, the composite agentic system 100 provides improvements in operational flexibility by utilizing an orchestrator model to determine discrete processing tasks implicitly contained in (and extracted from) the user query and orchestrating completion of the discrete processing tasks to respond to the user query in a seamless, individualized manner. Indeed, through the orchestrator model, the composite agentic system 100 can determine the discrete processing tasks and assign the discrete processing tasks to corresponding agentic subsystems and utilize the agentic subsystems to further augment an instruction for a fine-tuned large language model and/or a response to a user account. Unlike prior systems reliant on overgeneralized (one-size-fits-all) models and that further lack an orchestration model that guides a plurality of agentic subsystem in generating personalized, augmented responses to user queries, the composite agentic system 100 thus flexibly orchestrates, adapts, and executes multiple tasks from a general (e.g., high level or multi-order) query without requiring explicit instructions for each individual task extracted from the query.

Further, through the multi-agent processing framework, the composite agentic system 100 can enable a user account to have seamless, tailored experiences across multiple platforms. Indeed, in addition to the orchestrator model of the framework, the composite agentic system 100 generates and implements fine-tuned LLMs as part of the multi-agent processing framework. The composite agentic system 100 further leverages the fine-tuned LLMs by generating augmented prompts tailored specifically to the fine-tuned LLMs. For example, the composite agentic system 100 can generate the processing framework to be an augmented prompt tailored with user-account-specific data that is further targeted specifically to a domain or other area of expertise (e.g., a behavior or action type) of a fine-tuned LLM. The composite agentic system 100 can utilize the multi-agent processing framework to enable the fine-tuned LLMs to provide data transformation, customized API calls, customized semantic instruction generation, and other services that facilitate communication between the composite agentic system 100 and multiple different services, databases, and third-party platforms. The fine-tuned LLMs, in combination with the orchestrator model, results in increased flexibility for the composite agentic system 100 compared to conventional systems.

Due at least in part to its improved accuracy and flexibility, the composite agentic system 100 can provide increased efficiency compared to conventional systems. For example, the composite agentic system 100 can provide a user interface to enable a user account to interact with a multi-agent processing framework that automatically (e.g., without user querying) interfaces with other multi-agent processing frameworks, systems, or platforms, to execute tasks. Responsive to receiving a user query, the composite agentic system 100 utilizes (as part of a multi-agent processing framework) an orchestrator model and agentic subsystems to identify and perform tasks, each agentic subsystem can be adapted to specific domains for the discrete tasks extracted from the input query. Indeed, through the multi-agent processing framework, the composite agentic system 100 can receive a single query within a single interface to extract, orchestrate, and execute a series of tasks (in the proper order of execution across various task-specific agents) extracted from the single query. The composite agentic system 100 thus reduces a number of interactions compared to prior systems, sometimes by orders of magnitude.

By consolidating the many applications, interfaces, and interactions prior systems require to execute individual, discrete tasks across different platforms into a single interface for interacting with a single multi-agent processing framework, the composite agentic system 100 not only reduces the number of interactions but also reduces computational resources (e.g., processing power and/or memory) required to process such interactions and/or facilitate simultaneous running of multiple applications or interfaces. Indeed, rather than expending excess memory by running—and caching data for—multiple domain-specific applications in tandem, the composite agentic system 100 can reduce the running applications (and the corresponding memory consumption) to a single instance capable of performing all tasks from a single query in a single interface. Such improvements are especially pronounced on mobile devices where simultaneously running and interacting with multiple applications for performing separate tasks (through respective applications/agents) can be prohibitively expensive or demanding on the device, slowing performance and reducing battery life.

As illustrated by the foregoing discussion, the present disclosure utilizes a variety of terms to describe features and advantages of the composite agentic system. Additional detail is now provided regarding the meaning of such terms. For example, as used herein, the term “multi-agent processing framework” can refer to an artificial intelligence model or system of interconnected models structured to interact with a user account and perform tasks for the user account. For example, a multi-agent processing framework can include, communicate with, or be made up of one or more agentic subsystems, each powered by respective large language models to receive, understand, and respond to user queries. In some cases, a multi-agent processing framework includes a stratified structure of subsystems, models or constituent layers, including: i) a primary agent model that interfaces with a client device for receiving queries and providing responses, ii) an orchestrator model that interfaces with the primary agent model by extracting discrete processing tasks from a user query, and orchestrates task completion by determining fine-tuned LLMs that can complete a task of the discrete processing tasks and interfacing with the agentic subsystems to provide tasks to the agentic subsystems, iii) a set of one or more agentic subsystems that interface with the orchestrator model to receive tasks, and interface with task-adapter layers to complete the tasks in a tailored/detailed manner, and iv) a set of one or more specialized or otherwise augmented LLMs that the composite agentic system 100 uses generate semantic instructions including data specific to a domain and a command executable by a agentic subsystem. Indeed, a multi-agent processing framework can include and perform both conversational capabilities and task-specific functionalities to enable the multi-agent processing framework to deliver personalized assistance to a user account. Further, the composite agentic system 100 can generate a multi-agent processing framework to be specific to a domain (e.g., such as air travel, healthcare, lodging) or an entity within a domain. Accordingly, the composite agentic system 100 can utilize the domain-specific or entity-specific multi-agent processing frameworks to create customized, personalized journeys for a user account within a domain or a specific entity within the domain. Specifically, the composite agentic system 100 can generate the domain-specific or entity-specific multi-agent processing frameworks to include action-oriented agentic subsystems, such as a listen agentic subsystem, an understand agentic subsystem, an assist agentic subsystem, an act agentic subsystem, a personalize agentic subsystem, and/or an optimize agentic subsystem that communicate via an agent-to-agent communication protocol to augment and accomplish tasks extracted from user queries.

Moreover, as used herein, the term “discrete processing task” can include or refer to an action relating to a user query. A discrete processing task can be explicitly or implicitly stated in a user query. For example, the composite agentic system 100 can receive a user query requesting to plan a family vacation. The composite agentic system 100 can process the user query to extract a first discrete processing task of identifying and/or confirming participants of the family vacation. Further, the composite agentic system 100 can process the user query to extract a second discrete processing task of identifying and/or confirming a timeframe for the family vacation, a third processing task of identifying a location of the vacation, a fourth processing task of identifying and/or confirming transportation to and from the location, and a fifth processing task of identifying and/or confirming lodging at the location. As the composite agentic system 100 extracts the discrete processing tasks from the user query, the composite agentic system 100 can determine an interrelatedness or dependence among the processing tasks. Further, in some embodiments the composite agentic system 100 can determine an action classification (or behavior classification) for a discrete processing task that indicates a corresponding action-oriented agentic subsystem for the composite agentic system 100 to provide the discrete processing task to in order to instantiate creating a personalized experience for the user account based on receiving the user query.

Additionally, the term “large language model” refers to a set of one or more machine learning models trained to perform computer tasks to generate or identify computing code and/or data in response to trigger events (e.g., user interactions, such as text queries and/or button selections). In particular, a large language model can be a neural network (e.g., a deep neural network and/or a transformer-based neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the composite agentic system utilizes a large language model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., semantic instructions for agentic subsystems) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a large language model.

Relatedly, as used herein, the term “orchestrator model” can include or refer to an artificial intelligence (AI) agent, an LLM, a set of heuristic rules and conditions defining transitions between tasks or model states, and/or an autonomous software program coordinates and manages execution of multiple distributed tasks, workflows, or services (e.g., in a predefined sequence) to achieve a specific application or process goal. In some embodiments, the orchestrator model can interact with a primary agent model. For example, the orchestrator model can receive a user query from the primary agent model, extract discrete processing tasks from the query, and orchestrate a completion of the discrete processing tasks by determining corresponding agentic subsystems for each of the discrete processing tasks.

Further, as used herein, the term “agentic subsystem” can include or refer to an AI agent, a set of AI agents, a set of heuristic rules and conditions defining transitions between tasks or model states, and/or an autonomous software program that interacts with an orchestrator model and a fine-tuned LLM to perform or execute discrete processing tasks, processes, or subroutines. In some embodiments, the agentic subsystem can receive discrete processing tasks from the orchestrator model. The agentic subsystem can autonomously determine, responsive to receiving the discrete processing tasks, to generate a query for the fine-tuned large language model regarding the discrete processing tasks. For example, the agentic subsystem can determine (or can receive instructions from an orchestrator model) to query its fine-tuned LLM for semantic instructions to complete the task. In some cases, the orchestrator model and/or the agentic subsystem determine to incorporate a fine-tuned LLM based on determining that, without additional semantic instruction or context, the agentic subsystem will execute at task below a threshold level of accuracy. In some embodiments, an agentic subsystem can include an orchestrator sub model. In some embodiments, the agentic system can include or otherwise be communicatively coupled with one or more LLMs, such as a fine-tuned LLM.

Moreover, as used herein, the term “agent-to-agent communication protocol” can include or refer to a set of heuristic rules and conditions defining data transmission between agentic subsystems, agentic subsystem states, tasks, and/or an autonomous software programs that manage augmentation and personalized execution of discrete processing tasks. In some embodiments, the agent-to-agent communication protocol can supplement the orchestrator model. For example, based on using a first agentic subsystem to generate an agent payload from a first discrete processing task, the composite agentic system can use the agent-to-agent communication protocol to determine a second agentic subsystem compatible with the agent payload and/or to convert the payload into a format compatible with the second agentic subsystem.

Further, as used herein, the term “agent payload” can refer to a data packet generated by an agentic subsystem of a multi-agent processing framework. In some embodiments, an agent payload includes an output generated from an agentic subsystem, along with instructions (e.g., in plain text or in computer code) for another agentic subsystem of the multi-agent processing framework to process the agent payload downstream (thereby generating its own agent payload for possible further processing, and so on down the line). In some embodiments, the composite agentic system 100 can identify a fine-tuned large language model to provide the agent payload to in order to cause the fine-tuned large language model to generate an instruction. Specifically, the composite agentic system 100 can generate the instruction to enable an entity-specific agent to complete a discrete processing task. The composite agentic system 100 can determine to provide the instruction to another agentic subsystem as an agent payload. In addition, the agent payload can be action-specific according to an action type of the agentic subsystem agentic subsystem (e.g., such as listen, understand, assist, act, personalize, optimize).

Additionally, as used herein, the term “processing framework output” can refer to an output of a multi-agent processing framework, such as an amalgamated response resulting from intermediary responses and/or execution of a series of functions extracted from a multi-order, cross-agent query. In some embodiments, the composite agentic system 100 can use a fine-tuned LLM or another LLM to generate the processing framework output to include a specialized instruction (e.g., such as a semantic instruction) to enable an entity-specific agent to complete a discrete processing task indicated by a user query. In some embodiments, the composite agentic system 100 can use the fine-tuned LLM or another LLM to generate the processing framework output to include a status update regarding the user query (e.g., for the composite agentic system 100 to then provide to the client device, such as through a user interface). In some embodiments, the composite agentic system 100 can generate the processing framework output to include an indication of a second multi-agent processing framework for the composite agentic system 100 to provide the user query to in order for the composite agentic system 100 to complete the discrete processing tasks indicated by the user query. In some embodiments, the processing framework output can be domain-specific (e.g., specific to an industry or a company within an industry) and can include multiple action indicators from multiple agent payloads. In some embodiments, the processing framework output can be a data construct that the composite agentic system 100 provides to a fine-tuned LLM to cause the fine-tuned LLM to generate a prompt or other form of semantic instruction.

Further, as used, herein, the term “domain” can refer to a specific industry, such as a group of organizations. In some embodiments, a domain can be a specific entity within an industry. For example, a domain can be a company within an airline industry, such as AMERICAN AIRLINES, DELTA AIRLINES, UNITED AIRLINES, SOUTHWEST AIRLINES, JETBLUE AIRWAYS, FRONTIER AIRLINES, SPIRIT AIRLINES, AIR CANADA, WESTJET, VOLARIS, VIVA AEROBUS, BRITISH AIRWAYS, AIR FRANCE, IBERIA, CHINA EASTERN AIRLINES, Etc.

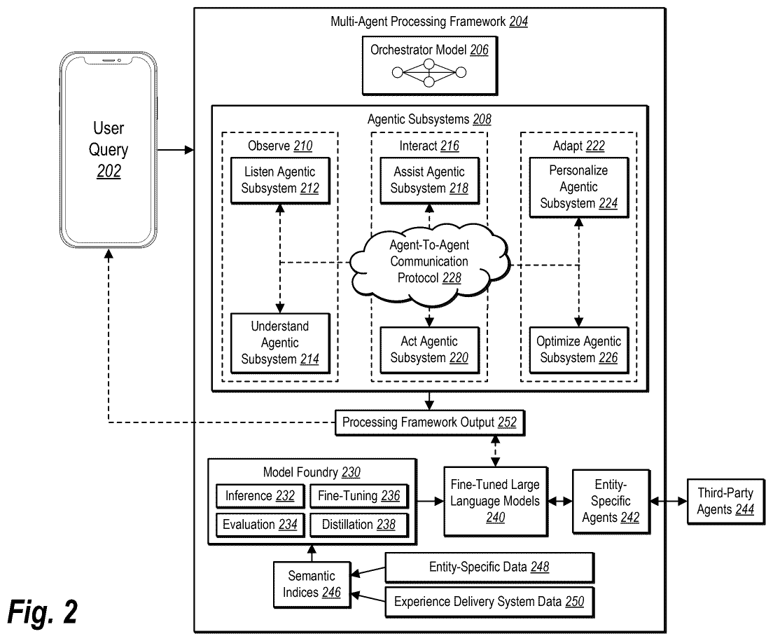

As previously mentioned, the composite agentic system 100 can utilize a multi-agent processing framework to receive a user query, extract discrete processing tasks from the user query, and determine an agentic subsystem from among a plurality of agentic subsystems to which to provide a first discrete processing task. For instance, the composite agentic system 100 can use agentic subsystems informed by fine-tuned LLMs. As shown in FIG. 2, the composite agentic system 100 can implement a multi-agent processing framework 204 to execute discrete processing tasks and to generate a query response in accordance with one or more embodiments.

As illustrated in FIG. 2, the composite agentic system 100 can receive a user query 202 (e.g., the user query 104 of FIG. 1). As previously discussed, the composite agentic system 100 can receive the user query 202 through a user interface (e.g., of a client device). Additionally, the composite agentic system 100 can receive the user query 202 through a plurality of modalities (e.g., as text or audio, among others). The composite agentic system 100 can provide the user query 202 to a multi-agent processing framework 204, whereupon the multi-agent processing framework 204 executes, processes, or augents discrete processing tasks to generate a processing framework output 252.

As illustrated in FIG. 2, the composite agentic system 100 can provide the user query 202 to an orchestrator model 206 within the multi-agent processing framework 204. In some embodiments, prior to providing the user query 202 to the orchestrator model 206, the composite agentic system 100 can use a primary agent model to process the user query 202 to determine whether the user query 202 contains security threats (e.g., aspects of the user query 202 that pose a risk to the operational security or integrity of the composite agentic system, such as jailbreaks (e.g., direct or indirect query injection attacks), context manipulation (e.g., such as role-playing or chain of queries), or model confusion (e.g., such as ambiguous queries or query overloading).

As illustrated in FIG. 2, the composite agentic system 100 can use the orchestrator model 206 to extract discrete processing tasks from the user query 202. For example, the composite agentic system 100 can use the orchestrator model 206 to dissect, segment, or otherwise process the user query 202 to determine the discrete processing tasks from the user query 202. In some embodiments, the discrete processing tasks can be implicitly rather than explicitly stated in the user query 202 (e.g., the composite agentic system 100 can identify one or more of the discrete processing tasks by implying one or more of the discrete processing tasks from the user query 202).

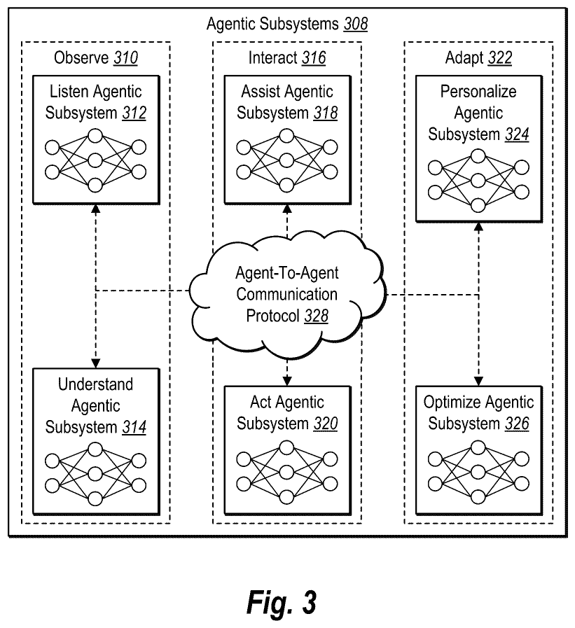

As shown in FIG. 2, responsive to using the orchestrator model 206 to extract the discrete processing tasks from the user query 202, the composite agentic system 100 can provide the discrete processing tasks to a plurality of agentic subsystems 208. In some embodiments, the composite agentic system 100 can determine action classifications for each of the discrete processing tasks and provide the processing tasks to a specific agentic subsystem based on the action classification. The plurality of agentic subsystems 208 can include a listen agentic subsystem 212 and an understand agentic subsystem 214 that correspond to a first subsystem classification (e.g., observe 210). Additionally, the plurality of agentic subsystems 208 can include an assist agentic subsystem 218 and an act agentic subsystem 220 that correspond to a second subsystem classification (e.g., interact 216). Further, the plurality of agentic subsystems 208 can include a personalize agentic subsystem 224 and an optimize agentic subsystem 226 that correspond to a third subsystem classification (e.g., adapt 222). Additionally, the composite agentic system 100 can use an agent-to-agent communication protocol 228 to facilitate communication between agentic subsystems of the plurality of agentic subsystems 208. More information regarding the plurality of agentic subsystems 208, their respective functionalities, and cooperation through the agent-to-agent communication protocol 228 can be found below with regard to the discussion of FIG. 3.

As illustrated in FIG. 2, the composite agentic system 100 can use the plurality of agentic subsystems to generate a processing framework output 252. The composite agentic system 100 can provide the processing framework output 252 to a fine-tuned large language model to complete a discrete processing task (e.g., of the discrete processing tasks). In some embodiments, the composite agentic system 100 can provide the processing framework output 252 to the client device as a status update relating to the user query 202.

As shown in FIG. 2, the composite agentic system 100 can use a model foundry 230 to generate the plurality of fine-tuned large language models 240. Specifically, the composite agentic system 100 can use the model foundry 230 to perform a plurality of tasks to generate the plurality of fine-tuned large language models 240. For example, the composite agentic system 100 can use the model foundry 230 to train, fine-tune, or otherwise enable the plurality of fine-tuned large language models 240 (or a specific fine-tuned large language model of the plurality of fine-tuned large language models) to perform inference 232 on user queries, discrete processing tasks, or processing framework outputs. To illustrate, the composite agentic system 100 can use the model foundry 230 to modify a large language model to generate inferences that are specific to a user account. Further, the composite agentic system 100 can use the model foundry 230 to perform fine-tuning 236 on a large language model, such as using entity-specific data 248 (e.g., a specific entity within a domain, such as an airline company within the domain of air travel) experience delivery system data 250 from semantic indices 246 to generate the plurality of fine-tuned large language models 240. More information regarding the composite agentic system 100 performing fine-tuning 236 to generate the plurality of fine-tuned large language models from entity-specific data 248 and experience delivery system data can be found in U.S. patent application Ser. No. 19/044,442, (the '442 application), titled ARTIFICIAL INTELLIGENCE AGENTS WITH DOMAIN-SPECIFIC TASK ADAPTER LAYERS FOR LARGE LANGUAGE MODELS, filed on Feb. 3, 2025. The aforementioned application is incorporated by reference in its entirety.

Further, the composite agentic system 100 can use the model foundry 230 to modify large language models to perform distillation 238 on inputs and outputs of the large language models. For example, the composite agentic system 100 can use the model foundry 230 to modify large language models to perform distillation 238 by pre-processing inputs to large language models and post-processing outputs of large language models to remove redundant or inaccurate information (e.g., information that the composite agentic system 100 determines does not meet a threshold relevance for the user query 202).

In addition, the composite agentic system 100 can use the model foundry 230 to perform evaluation 234 on the fine-tuned large language models 240. For example, the composite agentic system 100 can use the model foundry to perform evaluation 234 by determining an inference accuracy score for an inferred input and/or output of a fine-tuned large language model (e.g., of the plurality of fine-tuned large language models 240) and modifying parameters of the fine-tuned large language model according to the inference accuracy score. Further, the composite agentic system 100 can perform evaluation 234 by determining a distillation accuracy score for a distilled input and/or output of the fine-tuned large language model (e.g., of the plurality of fine-tuned large language models 240) and modifying parameters of the large language model according to the distillation accuracy score.

As illustrated in FIG. 2, the composite agentic system 100 can use the plurality of fine-tuned large language models 240 to provide instructions to entity-specific agents 242 to enable the entity-specific agents 242 to complete a task indicated by the processing framework output 252. In some embodiments, the composite agentic system 100 can further use the entity-specific agents 242 to interface with third-party agents 244 to complete the discrete processing tasks associated with the user query 202 (or otherwise indicated by the processing framework output 252). More information regarding the composite agentic system 100 using entity-specific agents 242 and third-party agents 244 to execute discrete processing tasks can be found in U.S. patent application Ser. No. 19/044,442 referenced and incorporated above.

As previously mentioned, the composite agentic system 100 can use a plurality of agentic subsystems to generate a processing framework output in response to receiving a user query. For example, the composite agentic system 100 can receive a user query, extract a first discrete processing task from the user query using an orchestrator model, and determine to provide the first discrete processing task to an assist agentic subsystem. Further, the composite agentic system 100 can use the assist agentic subsystem to generate an agent payload and provide the agent payload to an act agentic subsystem through an agent-to-agent communication protocol. Based on providing the agent payload to the act agentic subsystem, the composite agentic system 100 can use the act agentic subsystem to generate a processing framework output from the agent payload. FIG. 3 illustrates the plurality of agentic subsystems that the composite agentic system 100 can orchestrate through an agent-to-agent communication protocol to generate a processing framework output in accordance with one or more embodiments.

As previously discussed, the composite agentic system 100 can generate, customize, and utilize a multi-agent processing framework specific to a user query. Specifically, the composite agentic system 100 can generate the multi-agent processing framework to include an orchestrator model and a plurality of agentic subsystems 308 interconnected by an agent-to-agent communication protocol 328. Further, the composite agentic system 100 can organize the plurality of agentic subsystems 308 according to a plurality of subsystem classifications, such as observe 310, interact 316, and adapt 322. For example, the composite agentic system 100 can generate or otherwise structure the observe 310 subsystem classification to include a listen agentic subsystem 312 and an understand agentic subsystem 314. Further, the composite agentic system 100 can generate or otherwise structure the interact 316 subsystem classification to include an assist agentic subsystem 318 and an act agentic subsystem 320. Additionally, the composite agentic system 100 can generate or otherwise structure the adapt 322 subsystem classification to include a personalize agentic subsystem 324 and an optimize agentic subsystem 326.

The composite agentic system 100 can utilize the subsystem classifications and their corresponding agentic subsystems to perform a variety of tasks for a user account. For example, the composite agentic system 100 can utilize the agentic subsystems of the observe 310 subsystem classification (e.g., the listen agentic subsystem 312 and the understand agentic subsystem 314) to observe data streams across a plurality of modalities associated with the user account and identify data items from the plurality of streams that relate to user account. For example, the listen agentic subsystem 312 can be a plurality of agents that the composite agentic system 100 can use to monitor a plurality of data streams across a plurality of client devices.

Specifically, the composite agentic system 100 can use the listen agentic subsystem 312 to monitor interactions related to the user account across a plurality of platforms (e.g., such as websites, applications, etc.). To illustrate, the composite agentic system 100 can use the listen agentic subsystem 312 to perform semantic monitoring of user account interactions across the plurality of platforms and/or across the plurality of data streams. Specifically, the composite agentic system 100 can use the listen agentic subsystem 312 to decompose the user account interactions and/or data streams in real time (e.g., simultaneously or contemporaneously to determining or identifying the data streams) to identify data items corresponding to specific entities. To illustrate, the composite agentic system 100 can use the listen agentic subsystem 312 to autonomously monitor for and extract data items for the user account, such as credit alerts, travel alerts, weather alerts, news alerts, medical alerts, government alerts, among others.

Based on identifying the data items, the composite agentic system 100 can use the agent-to-agent communication protocol 328 to provide the data items to the understand agentic subsystem 314. The composite agentic system 100 can use the understand agentic subsystem 314 to process the data items to determine semantic understandings from the data items. The composite agentic system 100 can thus generate a contextual data construct (e.g., a plain text description or a computer code data object) defining or encoding the semantic understanding. To illustrate, the composite agentic system 100 can use the understand agentic subsystem 314 to determine a user-account-specific relevance of one or more of the data items. For example, the composite agentic system 100 can use the understand agentic subsystem 314 to determine a subset of the plurality of data items that are above a threshold level of relevance to the user account and accordingly can surface the subset of data items to the user account.

As illustrated, the composite agentic system 100 can use the interact 316 classification of agentic subsystems to interact directly with the user account. For example, the composite agentic system 100 can use the assist agentic subsystem 318 to provide natural language responses to the user account. To illustrate, where the composite agentic system 100 receives a query and utilizes the orchestrator model to determine that at least part of the query is a request for information. In some embodiments, based on identifying the request for information, the composite agentic system 100 can utilize one or more agentic subsystems of the observe 310 subsystem classification to generate or otherwise determine a contextual reference for the request for information (e.g., such as by generating or otherwise extracting one or more semantic relationships from the request for information). Based on using the one or more agentic subsystems of the observe 310 subsystem classification to determine a contextual reference for the request for information, the composite agentic system 100 can use the assist agentic subsystem 318 to provide the information to the user account. Further, in some embodiments, the composite agentic system 100 can surface one or more data items that the composite agentic system 100 identified using the understand agentic subsystem 314.

Further, the composite agentic system 100 can use the act agentic subsystem 320 to automatedly (e.g., without user interaction instigating) perform actions for the user account. For example, the composite agentic system 100 can receive a user query requesting the composite agentic system 100 to book a vacation for the user account. The composite agentic system 100 can use the orchestrator model to parse the user query to determine discrete processing tasks from the user query and provide a discrete task relating to booking flights to the act agentic subsystem 320. The composite agentic system 100 can use the act agentic subsystem to generate an instruction for a fine-tuned large language model to enable the fine-tuned large language model to orchestrate an entity-specific agent and/or a third party agent to purchase the flights for the user account.

As shown in FIG. 3, the composite agentic system 100 can use the adapt 322 classification of agentic subsystems to augment outputs of the observe 310 classification of agentic subsystems or the interact 316 classification of agentic subsystems. For example, the composite agentic system 100 can use the agent-to-agent communication protocol 328 to provide the personalize agentic subsystem 324 with an agent payload from the listen agentic subsystem 312, the understand agentic subsystem 314, the assist agentic subsystem 318, or the act agentic subsystem 320, and can use the personalize agentic subsystem 324 to augment the agent payload with data specific to the user account.

For example, in some embodiments, the composite agentic system 100 can provide a discrete processing task or an agent payload to the act agentic subsystem 320. The composite agentic system 100 can use the act agentic subsystem 320 to generate an instruction for a fine-tuned large language model to enable the fine-tuned large language model to complete the processing task for the user account (e.g., such as by using the fine-tuned large language model to interact with an entity-specific agent and/or a third-party agent). The composite agentic system 100 can use the personalize agentic subsystem 324 to process the instruction for the fine-tuned large language model to augment the instruction with personalized data to the user account, such as user account preferences, previous conversation history, among others.

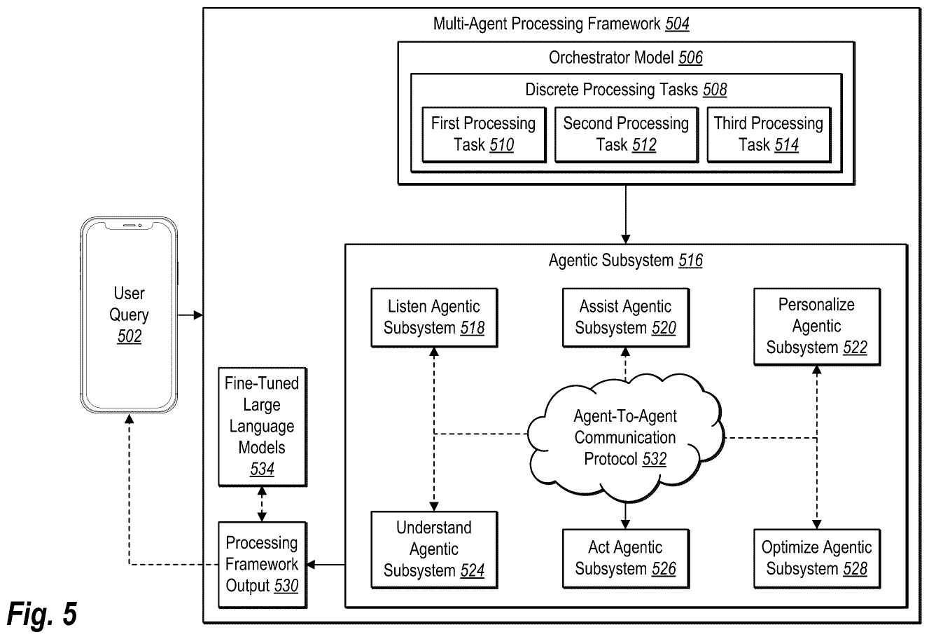

As shown in FIG. 3, the composite agentic system 100 can use the optimize agentic subsystem 326 to further augment outputs of the multi-agent processing framework. Indeed, the composite agentic system 100 can use the optimize agentic subsystem 326 to orchestrate completion of multiple discrete processing tasks for the user account to prioritize user account preferences. For example, the composite agentic system 100 can use the optimize agentic subsystem 326 to compare agent payloads corresponding to respective discrete processing tasks to augment the agent payloads according to user account preferences, among others. More information regarding the composite agentic system 100 using the optimize agentic subsystem is provided below with regard to FIG. 5.

Further, in some embodiments, one or more agentic subsystems of the plurality of agentic subsystems 308 can include an orchestrator layer. The composite agentic system 100 can use the agent-to-agent communication protocol 328 to communicate with the orchestrator layers of the agentic subsystems to determine a workflow for the discrete processing tasks related to the user query. Indeed, the composite agentic system 100 can use the agent-to-agent communication protocol 328 in tandem with the orchestrator model (of the overarching framework) to dynamically orchestrate and adapt workflows of the multi-agent processing framework. For example, the composite agentic system 100 can use the orchestrator model to initiate one or more workflows corresponding to a user query by extracting discrete processing tasks from the user query and identifying respective agentic subsystems from the plurality of agentic subsystems 308 to which to provide the discrete processing tasks.

Based on using the orchestrator model to assign discrete processing tasks to respective agentic subsystems, the composite agentic system 100 can use the agent-to-agent communication protocol 328 to iteratively refine and augment agent payloads and processing framework outputs. Based on iteratively refining and augmenting agent payloads and processing framework outputs, the composite agentic system 100 can generate processing framework outputs that are adapted specifically to user account preferences, thus creating seamless journeys for user accounts within entity-specific multi-agent processing frameworks. Indeed, the composite agentic system 100 can create these seamless journeys by using the observe 310 classification of agentic subsystems to monitor user account interactions across platforms. Further, the composite agentic system 100 can create the seamless user journeys by using the interact 316 classification of agentic subsystems to directly interact with the user account. Moreover, the composite agentic system 100 can create the seamless user journeys by using the adapt 322 classification of agentic subsystems to adapt agent payloads and/or processing framework outputs specifically the user account.

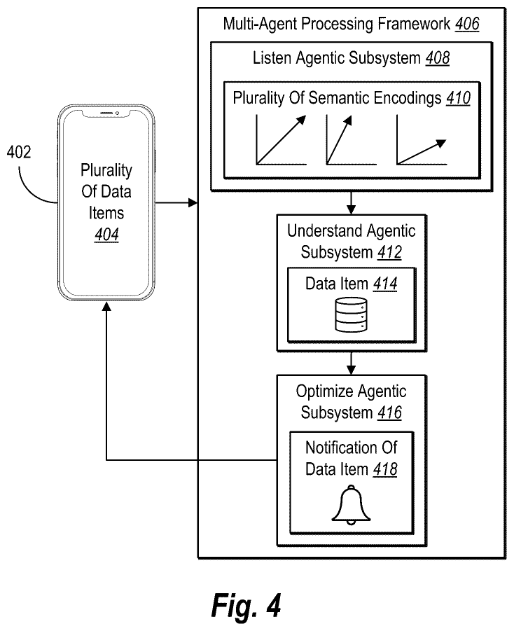

As previously mentioned, in some embodiments, the composite agentic system 100 can surface a notification of a data item to a user account. For example, the composite agentic system 100 can detect a plurality of items relating to fraudulent usage of a credit card of a user account and surface a notification of the fraudulent credit card. FIG. 4 illustrates the composite agentic system 100 using a listen agentic subsystem, an understand agentic subsystem, and an optimize agentic subsystem to surface a notification of a data item to a user account in accordance with one or more embodiments.

As shown in FIG. 4, the composite agentic system 100 can monitor a client device 402 associated with a user account to identify a plurality of data items 404 associated with the user account. In some embodiments, the composite agentic system 100 can monitor a plurality of client devices associated with the user account to identify the plurality of data items 404. The plurality of data items 404 can correlate or otherwise be associated with interactions of the user account across a variety of platforms. For example, the plurality of data items 404 can include user account interactions with entities within domains (e.g., such as healthcare providers, financial institutions, air travel entities, social media platforms, among others) on websites or applications. Indeed, the composite agentic system 100 can continually monitor user account interactions and determine or otherwise extract the plurality of data items 404 in real-time.

As shown in FIG. 4, based on identifying the plurality of data items 404, the composite agentic system 100 can provide the plurality of data items 404 to a multi-agent processing framework 406. In some embodiments, the composite agentic system 100 can provide the plurality of data items 404 to an orchestrator model of the multi-agent processing framework 406. The composite agentic system 100 can use the orchestrator model to determine to provide the plurality of data items 404 to a listen agentic subsystem 408. The composite agentic system 100 can use the listen agentic subsystem 408 to process the plurality of data items 404 to generate a plurality of semantic encodings 410 that correspond to the plurality of data items 404. As used herein, the term “semantic encoding” can refer to an embedding that represents a semantic meaning/relationship/ and/or intention of the plurality of data items. For example, the composite agentic system 100 can generate a semantic encoding to represent the plurality of data items 404 in a context that encompasses interactions of the user account across a variety of platforms.

For example, the composite agentic system 100 can identify and extract the plurality of data items 404 in real-time. Further, the composite agentic system 100 can use the listen agentic subsystem 408 to decompose the plurality of data items 404 in real time to generate the plurality of semantic encodings 410 that reflect semantic and contextual relationships between the user account and a plurality of entities across the plurality of platforms. Further, the composite agentic system 100 can determine to provide (e.g., such as by using an agent-to-agent communication protocol of the multi-agent processing framework 406) the plurality of semantic encodings 410 to an understand agentic subsystem 412.

Based on providing the plurality of semantic encodings 410 to the understand agentic subsystem 412, the composite agentic system 100 can use the understand agentic subsystem 412 to identify a data item 414 of the plurality of data items 404 to surface to the user account of the client device 402. For example, the composite agentic system 100 can use the understand agentic subsystem 412 to process the plurality of semantic encodings 410 to determine that one or more of the plurality of semantic encodings 410 exceeds one or more relevance thresholds. The composite agentic system 100 can set or otherwise determine the one or more relevance thresholds according to different aspects of relevance to the user account, such as relevance due to a data item that corresponds to a risk of a security threat (e.g., such as potential credit card threat), relevance due to a data item that corresponds to a temporal urgency (e.g., such as a sale), relevance due to a data item that corresponds to travel plans corresponding to a user account (e.g., such as a change in flight times of flights corresponding to the user account), among others.

For example, the composite agentic system 100 can compare (e.g., such as by determining a cosine similarity) the plurality of semantic encodings 410 to a first relevance threshold that corresponds to security risks to determine that one or more of the plurality of semantic encodings 410 corresponds to an abnormal activity that could indicate a security risk for the user account. To illustrate, the composite agentic system 100 can include data items in the plurality of data items 404 that correspond to purchases made with a credit card that corresponds to the user account. The composite agentic system 100 can generate the plurality of semantic encodings 410 corresponding to the plurality of data items 404 that contextualize the plurality of data items 404, such as by contextualizing the data items corresponding to the purchases with additional information about the purchases, such as what time they were made, what items or services were purchased with the credit card, an IP address used to make the purchase with the credit card, etc. The composite agentic system 100 can use the understand agentic subsystem 412 to compare the plurality of semantic encodings 410 to a first relevance threshold that indicates behavioral norms for the user account over a period of time. The composite agentic system 100 can determine that a semantic encoding of the plurality of semantic encodings 410 exceeds the first relevance threshold, thus indicating that a data item 414 corresponding to the semantic encodings is abnormal when compared to behavioral norms of the user account.

As illustrated in FIG. 4, the composite agentic system 100 can provide the data item 414 to an optimize agentic subsystem 416. Based on providing the data item 414 to the optimize agentic subsystem 416, the composite agentic system 100 can use the optimize agentic subsystem 416 to generate a notification of the data item 418 and surface the data item 414 to the user account by providing the notification of the data item 418 to the client device 402. For example, the composite agentic system 100 can generate the notification of the data item 418 to include a contextualized description of the data item 414 (e.g., that the composite agentic system 100 derives from the semantic encoding of the plurality of semantic encodings 410) as well as an explanation of why the composite agentic system 100 surfaced the data item 414 to the client device 402. Further, the composite agentic system 100 can use the optimize agentic subsystem 416 to optimize or otherwise personalize the notification of the data item 418 according to data for the user account. Further, in some embodiments, the composite agentic system 100 can generate the notification of the data item 418 as part of a processing framework output to provide to the client device 402.

Additionally, in some embodiments, the composite agentic system 100 can use an agentic subsystem than the optimize agentic subsystem 416 to generate the notification of the data item 418 and/or the processing framework output. For example, the composite agentic system 100 can track or monitor which agentic subsystems the composite agentic system 100 has used to generate agent payloads and/or processing framework outputs. For example, the composite agentic system 100 can select an agentic subsystem to use to generate the notification of the data item 418 and/or the processing framework output according which agentic subsystems the composite agentic system 100 used to generate agent payloads and/or processing framework outputs. To illustrate, the composite agentic system 100 can generate the processing framework output by selecting an agentic subsystem from among set that includes: the listen agentic subsystem 408, the understand agentic subsystem 412, an assist agentic subsystem, an act agentic subsystem, an act agentic subsystem, a personalize agentic subsystem, and the optimize agentic subsystem 416.

As previously mentioned, in some embodiments, the composite agentic system 100 can extract discrete processing tasks from a user query and orchestrate a plurality of agentic subsystems to complete the discrete processing tasks. For example, the composite agentic system 100 can receive a user query requesting the composite agentic system 100 to plan a vacation for a user account corresponding to a user and additional user accounts corresponding to family members of the user. FIG. 5 illustrates the composite agentic system 100 receiving a user query, extracting a plurality of discrete processing tasks from the user query, and utilizing a plurality of agentic subsystems to generate a processing framework output 530 that corresponds to the user query 502 in accordance with one or more embodiments.

As shown in FIG. 5, the composite agentic system 100 can receive a user query 502 from a client device that corresponds to a user account. For example, the user query 502 can be a request for the composite agentic system 100 to plan a vacation to Mexico for a user corresponding to the user account, as well as a second user account corresponding to a spouse of the user and a third user account corresponding to a child of the user (for example, user query 502 could state “plan a vacation for me, my husband, and my child to Mexico for this upcoming Spring Break.”). The composite agentic system 100 can provide the user query 502 to a multi-agent processing framework 504.

As shown in FIG. 5, based on providing the user query 502 to the multi-agent processing framework 504, the composite agentic system 100 can use an orchestrator model 506 of the multi-agent processing framework 504 to extract a plurality of discrete processing tasks 508 from the user query 502. For example, the composite agentic system 100 can extract the plurality of discrete processing tasks 508 by extracting a first processing task 510, a second processing task 512, and a third processing task 514. For example, the composite agentic system 100 can determine that the first processing task 510 corresponds to determining travel plans for the user account, the second processing task 512 corresponds to determining travel plans for the second user account, and the third processing task 514 corresponds to the third user account.

As illustrated in FIG. 5, the composite agentic system 100 can provide the plurality of discrete processing tasks 508 to a plurality of agentic subsystems 516. Based on providing the plurality of discrete processing tasks 508 to the plurality of agentic subsystems 516, the composite agentic system 100 can use an agent-to-agent communication protocol 532 to orchestrate an execution of the plurality of discrete processing tasks 508. Further, the composite agentic system 100 can use the agent-to-agent communication protocol 532 to determine that the first processing task 510, the second processing task 512, and the third processing task 514 each include a group of subtasks.

As shown in FIG. 5, the composite agentic system 100 can use the agent-to-agent communication protocol 532 to begin orchestrating workflows to execute the plurality of discrete processing tasks 508. For example, the composite agentic system 100 can determine to use an assist agentic subsystem 520 to clarify a date range for the vacation. Accordingly, the composite agentic system 100 can use the assist agentic subsystem 520 to generate an agent payload that is a query response to provide to the client device. For example, the query response could be “What dates did you mean by ‘Spring Break?’ Simultaneously, the composite agentic system 100 can use a listen agentic subsystem 518 to extract a plurality of data items from data streams corresponding to the user account that further correspond to an aspect of the plurality of discrete processing tasks 508. The composite agentic system 100 can then provide the plurality of data items to an understand agentic subsystem 524 to cause the understand agentic subsystem 524 to generate a plurality of semantic encodings that correspond to the plurality of data items. The composite agentic system 100 can analyze the plurality of semantic encodings to determine one or more date ranges that correspond to the phrase “Spring Break.”

Based on analyzing the plurality of semantic encodings, the composite agentic system 100 can use the understand agentic subsystem 524 to identify a subset of data items that provide or otherwise contextualize the phrase “Spring Break.” For example, the subset of data items can include a first data item that corresponds to a first range of available dates for the user account, such as March 9-March 15. Additionally, the subset of data items can include a second data item that corresponds to a second range of available dates for the second user account, such as March 10-March 19. Further, the subset of data items can include a third data item that corresponds to a third range of available dates for the third user account, such as March 11-March 18. Based on using the listen agentic subsystem 518 and the understand agentic subsystem 524 to identify the subset of data items, the composite agentic system 100 can provide the subset of data items to an optimize agentic subsystem 528.

For example, the composite agentic system 100 can provide, using the agent-to-agent communication protocol 532, the subset of data items and the agent payload to the optimize agentic subsystem 528 to use the optimize agentic subsystem 528 to augment the agent payload using the subset of data items. To illustrate, the composite agentic system 100 can augment the user payload to reflect information from the subset of data items. Thus, rather than generating the agent payload to recite “What dates did you mean by ‘Spring Break?” the composite agentic system 100 can augment the augment the agent payload to recite something like “I found three different potential available date ranges corresponding to ‘Spring Break.’ Your available dates are March 9-March 17, your spouse's available dates are March 10-March 19. Your child's available dates are March 11-March 18. The dates you all have available are March 11-March 17. Would you like me to make arrangements for all of you for those dates or would you each like your own sets of travel plans on your respectively available dates?” As just demonstrated, the composite agentic system 100 can use the optimize agentic subsystem 528 to optimize an agent payload (and/or a processing framework output 530) by resolving one or more conflicting data items from a plurality of data items the composite agentic system 100 used the understand agentic subsystem 524 to identify.

Based on receiving a response to the agent payload from the optimize agentic subsystem 528, the composite agentic system 100 can further determine a first subset of processing tasks from the first processing task 510, a second subset of processing tasks from the second processing task 512, and a third subset of processing tasks from the third processing task 514, wherein each subset of processing tasks can include a processing task corresponding to determining flight plans for a respective user account, determining travel plans to and from an airport for the respective user account, a processing task for determining lodging for the respective user account. In some embodiments, the composite agentic system 100 can determine the first, second, and third subsets of processing tasks using the orchestrator model 506. In some embodiments, the composite agentic system 100 can determine the first, second, and third subsets of processing tasks from their respective processing tasks using the agent-to-agent communication protocol 532 and/or an agentic subsystem of the plurality of agentic subsystems. For example, in some embodiments, the composite agentic system 100 can use the optimize agentic subsystem 528 to determine the first, second, and third subsets of processing tasks from their respective processing tasks and can further use the agent-to-agent communication protocol 532 to determine an agentic subsystem of the plurality of agentic subsystems 516 to provide the first, second, and third subsets of tasks to.

To illustrate, the composite agentic system 100 can determine to provide the first, second, and third subsets of processing tasks to an act agentic subsystem 526. Based on providing the first, second, and third subsets of processing tasks to the act agentic subsystem 526, the composite agentic system 100 can use the act agentic subsystem 526 to generate an agent payload that includes sets of instructions for fine-tuned large language models 534 to enable the fine-tuned large language models 534 to complete the subsets of tasks. The composite agentic system 100 can use the agent-to-agent communication protocol 532 to provide the agent payload to a personalize agentic subsystem 522. Based on providing the sets of instructions to the personalize agentic subsystem 522, the composite agentic system 100 can use the personalize agentic subsystem 522 to augment the sets of instructions with user account-specific data. For example, the composite agentic system 100 can use the personalize agentic subsystem 522 to augment the agent payload by specifying user account preferences for aspects such as flight preferences (e.g., seating preferences such as first class, business class window seat, aisle seat, front of the plane, back of the plane, or preferences for an airline entity, times of departure and arrival, among others), lodging preferences (e.g., a preferred entity to stay at, such as a hotel), destination preferences for the vacation (e.g., such as a specific state in Mexico or a specific resort), among others.

In parallel, the composite agentic system 100 can also use the listen agentic subsystem 518 and the understand agentic subsystem 524 to extract data items and generate semantic encodings for the data items relating to the travel plans. For example, the composite agentic system 100 can autonomously determine to use the listen agentic subsystem 518 and the understand agentic subsystem 524 to search for deals or promotions on flights or lodgings. The composite agentic system 100 can provide an agent payload from the personalize agentic subsystem 522 (e.g., that the composite agentic system 100 generates to include a personalized set of instructions for the composite agentic system 100 to provide to the fine-tuned large language models 534) and an agent payload from the understand agentic subsystem 524 (e.g., that the composite agentic system 100 generates to include a data item corresponding to any promotions relating to travel plans) to the optimize agentic subsystem 528.

To illustrate, the composite agentic system 100 can utilize the optimize agentic subsystem 528 to resolve any conflicts between agent payload from the understand agentic subsystem 524 and the personalize agentic subsystem 522. For example, the composite agentic system 100 can determine that the agent payload from the personalize agentic subsystem 522 indicates a first user account preference for flying with a specific airline, such as DELTA as well as a second user account preference for flights that leave in the mid-morning. Further, the composite agentic system 100 can determine that the agent payload from the understand agentic subsystem 524 indicates that flights from DELTA that match the timeline are red-eye flights, but that flights from AMERICAN AIRLINES leave in the mid-morning (thus indicating a conflict between user account preferences for airline and flight departure time). The composite agentic system 100 can use the optimize agentic subsystem 528 to resolve the conflict between user preferences (for example by generating a prompt to provide to the user account or by processing previous conversations with the user account to determine if the composite agentic system 100 had resolved a similar conflict previously).

As shown in FIG. 5, the composite agentic system 100 can use the plurality of agentic subsystems 516 iteratively to generate and augment agent payloads, resulting in a processing framework output 530. In some embodiments, the processing framework output 530 can include prompts that enable fine-tuned large language models 534 to complete the plurality of discrete processing tasks 508 (e.g., by causing the fine-tuned large language models 534 to generate instructions enabling entity-specific agents to execute the plurality of discrete processing tasks 508). For example, the composite agentic system 100 can generate the processing framework output 530 to include a first set of prompts to provide to a first set of fine-tuned large language models 534 to enable the first set of fine-tuned large language models 534 to complete the first processing task 510. Further, the composite agentic system 100 can generate the processing framework output 530 to include a second set of prompts to provide to a second set of fine-tuned large language models 534 to enable the second set of fine-tuned large language models 534 to complete the second processing task 512. Additionally, the composite agentic system 100 can generate the processing framework output 530 to include a third set of prompts to provide to a third set of fine-tuned large language models 534 to complete the third processing task 514. Moreover, the composite agentic system 100 can generate the processing framework output 530 to include a status update regarding the user query 502 to provide to the device.

As illustrated by the foregoing discussion, the composite agentic system 100 can orchestrate an order of completion of the discrete processing tasks according to one or more dependencies or levels of relatedness among the discrete processing tasks. For example, when the composite agentic system 100 extracts (for example using the orchestrator layer), the composite agentic system 100 can determine inputs or information required for the composite agentic system 100 to complete the discrete processing tasks. As previously mentioned, in response to receiving a user query that requests the composite agentic system 100 to plan a family vacation, the composite agentic system 100 can determine a first discrete processing task for identifying members of the family that will participate in the vacation (e.g., participants). Further, the composite agentic system 100 can determine a second discrete processing task of identifying a timeline for the family vacation. Based on determining the first and second discrete processing tasks, the composite agentic system 100 can determine to execute the first and second discrete processing tasks in series.

To illustrate, the composite agentic system 100 can execute or otherwise complete the first processing task to generate a first processing framework output that indicates participants in the family vacation. Based on generating the first processing framework output, the composite agentic system 100 can use the first processing framework output to inform workflows relating to the second discrete processing task. To illustrate, based on identifying the participants of the vacation, the composite agentic system 100 can identify a timeline for the family vacation (e.g., by determining individual availabilities for each participant and determining a group availability based on the individual availabilities). The composite agentic system 100 can generate a second processing framework output to indicate a time range for the vacation.

Further, the composite agentic system 100 can determine a third discrete processing task of confirming travel plans for each member of the family (e.g., the third discrete processing task can include a subset of discrete processing tasks, wherein each of the subset of discrete processing tasks corresponds to travel plans for a member of the family). The composite agentic system 100 can determine that the third processing task is dependent upon the first processing framework output and the second processing framework output. Further, the composite agentic system 100 can determine that one or more processing tasks of the subset of discrete processing tasks are independent (e.g., by determining that travel plans for a first member of the family are not dependent on travel plans for the second member of the family, such as by determining that the first member of the family and the second member of the family live in different cities and will not have the same travel arrangements). Accordingly, the composite agentic system 100 can determine to simultaneously (e.g., in parallel) execute one or more of the subset of discrete processing tasks in order to quickly and efficiently generate a response to the user query.

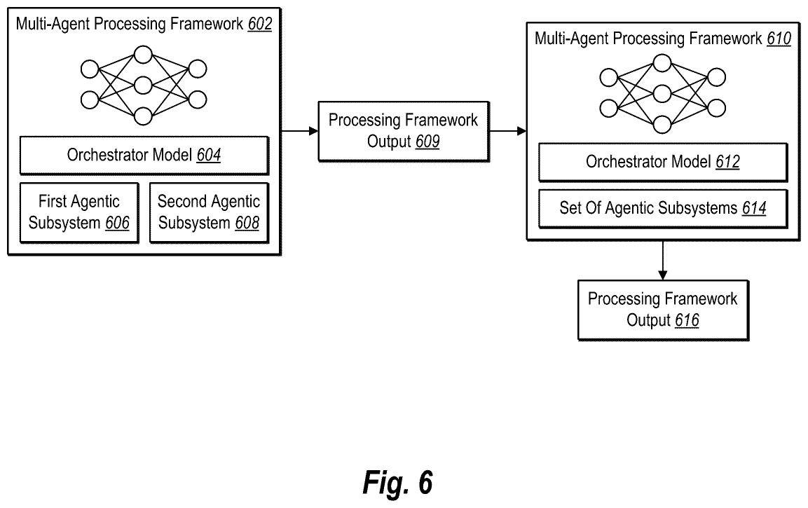

As previously mentioned, in some embodiments, the composite agentic system 100 can provide a processing framework output from the multi-agent processing framework to a second multi-agent processing framework to cause the second multi-agent processing framework to generate a second processing framework output. For example, the composite agentic system 100 can receive a user query that includes a plurality of discrete processing tasks corresponding to a plurality of domains. The composite agentic system 100 can use a first multi-agent processing framework corresponding to a first domain to generate a first processing framework output corresponding to a first processing task associated with the first domain. The composite agentic system 100 can provide the first processing framework output to a second multi-agent processing framework corresponding with a second domain to cause the second multi-agent processing framework to generate a second processing framework output. FIG. 6 illustrates the composite agentic system 100 using a first multi-agent processing framework to generate a first processing framework output and providing the first processing framework output to a second multi-agent processing framework to cause the second multi-agent processing framework to generate a second processing framework output in accordance with one or more embodiments.

As shown in FIG. 6, the composite agentic system 100 can use a multi-agent processing framework 602 (e.g., a first multi-agent processing framework) to generate a processing framework output 609 (e.g., a first processing framework output). As previously discussed, the composite agentic system 100 can generate the multi-agent processing framework 602 to be domain-specific or entity-specific. Specifically, the composite agentic system 100 can generate or otherwise structure the first multi-agent processing framework 602 to include an orchestrator model 604 that orchestrates workflows among a plurality of agentic subsystems (e.g., a first agentic subsystem 606 and a second agentic subsystem 608) in a manner that is unique to the domain and/or entity. Further, the composite agentic system 100 can generate the multi-agent processing framework 602 to include fine-tuned large language models that have been fine-tuned with data unique to the domain or entity. Additionally, the composite agentic system 100 can generate the multi-agent processing framework 602 to include entity-specific agents (e.g., agentic models that the composite agentic system 100 attenuates and utilizes to execute entity-specific workflows within the domain.

Accordingly, in some embodiments, the composite agentic system 100 can orchestrate a plurality of multi-agent processing frameworks to generate a response to a user query. For example, the composite agentic system 100 can use the multi-agent processing framework 602 to receive a user query. The composite agentic system 100 can use the orchestrator model 604 of the multi-agent processing framework 602 to extract a plurality of discrete processing tasks from the user query. Further, the composite agentic system 100 can use the orchestrator model 604 to classify each of the plurality of discrete processing tasks with a task classification and/or a domain classification. Based on classifying each of the plurality of discrete processing tasks, the composite agentic system 100 can determine to use the multi-agent processing framework 602 to generate a processing framework output 609 that includes and corresponds to a first processing task of the plurality of discrete processing tasks. The composite agentic system 100 can select the first agentic subsystem 606 and the second agentic subsystem 608 from among a plurality of agentic subsystems of the multi-agent processing framework 602.

Further, the composite agentic system 100 can generate the processing framework output 609 to include an instruction for the multi-agent processing framework 610 to execute a second processing task of the plurality of discrete processing tasks that corresponds to a second domain. For example, the composite agentic system 100 can determine to include the instruction for the multi-agent processing framework 610 to execute the second processing task responsive to a determination that the multi-agent processing framework 602 cannot complete the second processing task at or above a threshold level of accuracy. For example, the composite agentic system 100 can determine that the composite agentic system 100 used data corresponding to the first domain to fine-tune the fine-tuned large language models associated with the multi-agent processing framework 602. Accordingly, the composite agentic system 100 can identify the multi-agent processing framework 610 (e.g., such as through a multi-agent processing framework-to-multi-agent processing framework communication protocol) and include the instruction for the multi-agent processing framework 610 to complete the second processing task in the processing framework output 609.

Based on providing the processing framework output 609 to the multi-agent processing framework 610, the composite agentic system 100 can use an orchestrator model 612 to use to generate a processing framework output 616. Specifically, the composite agentic system 100 can use the orchestrator model 612 to determine at least one agentic subsystem of a set of agentic subsystems that correspond to the multi-agent processing framework 610 generate the processing framework output 616. As illustrated in FIG. 6, the multi-agent processing framework 610 can be a different multi-agent processing framework than the multi-agent processing framework 602. Accordingly, the components of the multi-agent processing framework 610 can be different from the components of the multi-agent processing framework 602. For example, the multi-agent processing framework 602 can correspond to a first domain or entity, and the multi-agent processing framework 610 can correspond to a second domain or entity. In some embodiments, the processing framework output 616 can include the processing framework output 609 in addition to information that the composite agentic system 100 uses the set of agentic subsystems 614 (e.g., by utilizing the set of agentic subsystems 614 to generate instructions to provide to a set of fine-tuned large language models associated with the multi-agent processing framework 610 and/or the second domain to generate).

In some embodiments, multi-agent processing framework 602 can be associated with a first user account and the multi-agent processing framework 610 can be associated with a second user account. For example, referring to the example discussed previously with regard to FIG. 5 of a user account planning a vacation for their family to Mexico during spring break, the composite agentic system 100 can use the multi-agent processing framework 602 to execute discrete processing tasks related to the first user account and can further use the multi-agent processing framework 610 to execute discrete processing tasks related to the second user account, and can use a third multi-agent processing framework to execute discrete processing tasks related to the third user account.

To illustrate, the composite agentic system 100 can use the multi-agent processing framework 602 to generate the processing framework output 609 to provide to the multi-agent processing framework 610 that indicates details pertaining to the vacation, such as date ranges for the second user account, a destination, flight plans, travel plans to and from airports, lodging, etc. The composite agentic system 100 can provide the processing framework output 609 to the multi-agent processing framework 610 to use the multi-agent processing framework 610 to perform actions relating to the vacation, such as booking tickets for flights, booking lodging, etc. The composite agentic system 100 can use the multi-agent processing framework to generate a processing framework output 616 that indicates a completion or execution of the discrete processing tasks. Further, the composite agentic system 100 can provide the processing framework output 616 to a first client device associated with the first user account and to a second client device associated with the second user account to indicate to both user accounts that the composite agentic system 100 has completed discrete processing tasks relating to the user query (such as travel plans relating to the vacation) on behalf of both user accounts. In some embodiments, such as where the multi-agent processing framework 610 is associated with the second user account, the composite agentic system 100 can inform the second user account of the discrete processing tasks it will use the multi-agent processing framework 610 to execute and can further request an indication of permission from the second user account prior to utilizing the multi-agent processing framework 610 to execute the discrete processing tasks.

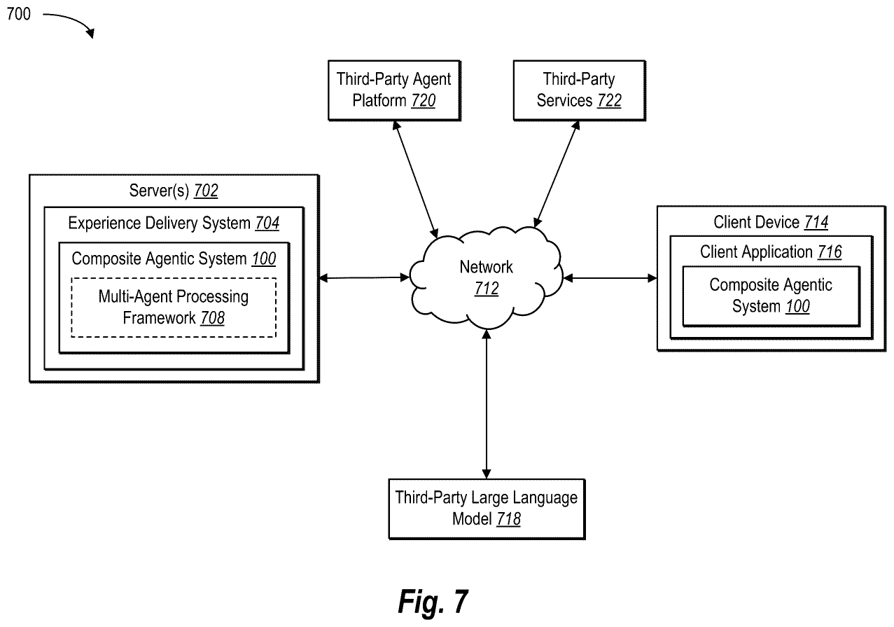

FIG. 7 illustrates a schematic diagram of an exemplary system environment (“environment”) 700 in which a composite agentic system 100 operates. As illustrated in FIG. 7, the environment 700 includes server(s) 702, a network 712, a client device 714, a third-party large language model 718, a third-party agent platform 720, and third-party services 722.

Although the environment 700 of FIG. 7 is depicted as having a particular number of components, the environment 700 is capable of having any number of additional or alternative components (e.g., any number of server devices, client devices, third-party servers, or other components in communication with the composite agentic system 100 via the network 712). Similarly, although FIG. 7 illustrates a particular arrangement of the server(s) 702, the network 712, the client device 714, the third-party large language model 718, the third-party agent platform 720 and the third-party services 722, various additional arrangements are possible.

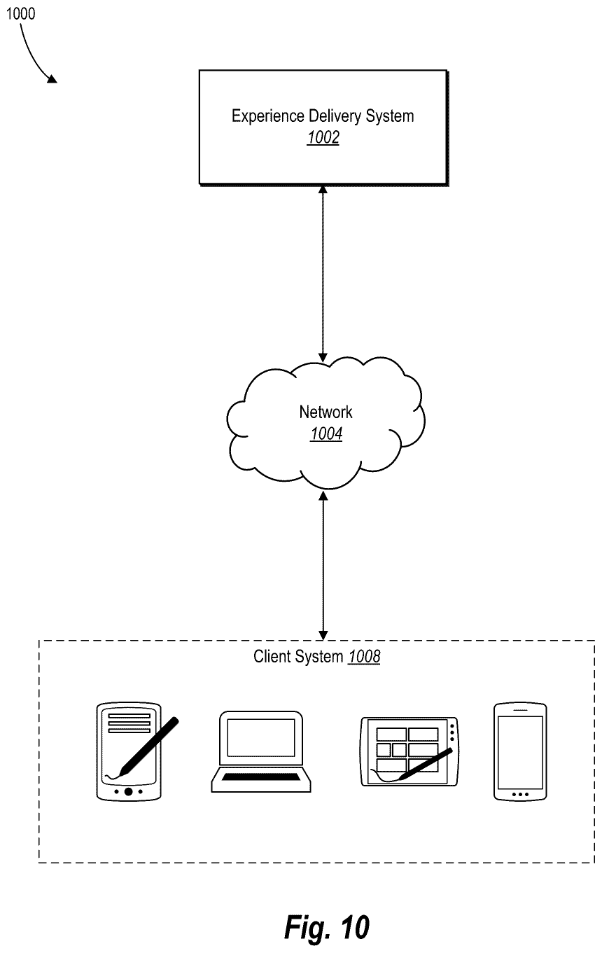

The server(s) 702, the network 712, the client device 714, the third-party large language model 718, the third-party agent platform 720 and the third-party services 722, are communicatively coupled with each other either directly or indirectly (e.g., through the network 712 discussed in greater detail below in relation to FIG. 10. Moreover, the server(s) 702, the client device 714, the third-party large language model 718, the third-party agent platform 720 and the third-party services 722, each include one of a variety of computing devices (including one or more computing devices as discussed in greater detail with relation to FIG. 10).

As mentioned above, the environment 700 includes the server(s) 702. In one or more embodiments, the server(s) 702 generates, stores, receives, and/or transmits data, including user queries, task queries, task responses, task item instructions, task statuses, and/or user responses. In one or more embodiments, the server(s) 702 comprises a data server. In some implementations, the server(s) 702 comprises a communication server or a web-hosting server.

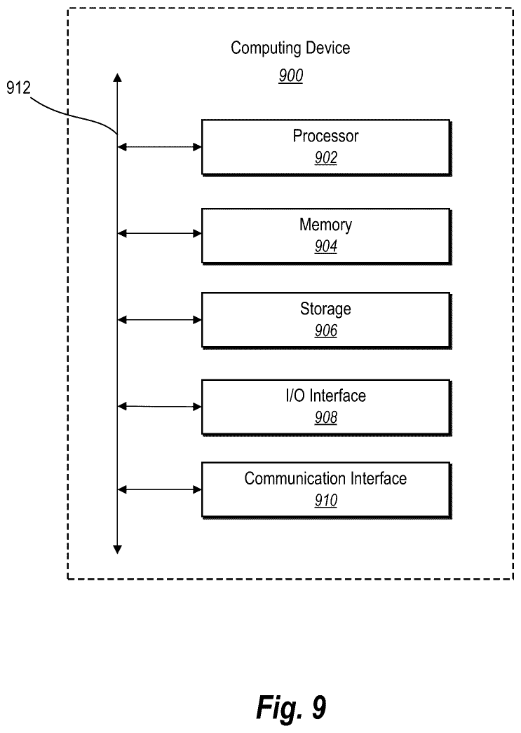

As mentioned above, the environment 700 includes a client device 714. The client device 714 can be one of a variety of computing devices, including a smartphone, a tablet, a smart television, a desktop computer, a laptop computer, a virtual reality device, an augmented reality device, or another computing device as described in relation to FIGS. 9-10. The client device 714 can communicate with the server(s) 702 via the network 712. For example, the client device 714 can receive user input from a user interacting with the client device 714 (e.g., via a client application 716) to, for instance, access, generate, modify, or share a content item, to collaborate with a co-user of a different client device, or to select a user interface element. In addition, the composite agentic system 100 on the server(s) 702 can receive information relating to various interactions with content items and/or user interface elements based on the input received by the client device 714.

As shown, the client device 714 can include a client application 716. In particular, the client application 716 may be a web application, a native application installed on the client device 714 (e.g., a mobile application, a desktop application, etc.), or a cloud-based application where all or part of the functionality performed by the server(s) 702. Based on instructions from the client application 716, the client device 714 can present or display information, including a user response the composite agentic system 100 generates according to a user query. Moreover, the client application 716 can be used to host part of or all of the composite agentic system 100. For example, the composite agentic system 100 can run or be hosted entirely on the client device 714 through the application. In some embodiments the composite agentic system 100 can be hosted on the server(s) 702 and displayed or shown at the client device 714.

In one or more embodiments, the experience delivery system 704 provides functionality that facilitates a communication between participants. For example, in some implementations, the experience delivery system 704 provides functionality for transmitting and/or recording a communication between users. In some embodiments, the experience delivery system 704 provides functionality that more specifically assists one user in communicating with another user. For instance, the experience delivery system 704 can provide functionality that enables a device of one of the users (e.g., a device used to transmit the communication or a separate, supplementary device) to display information relevant to the communication (e.g., to display information for the other user(s) participating in the communication, such as identifying information or account information).

In some embodiments, the experience delivery system 704 can include a knowledge graph of the experience delivery system 704. For example, the knowledge graph can include nodes representing users within the experience delivery system 704 and edges connecting the nodes that represent relationships between the users of the experience delivery system 704. The knowledge graph can include demographic data as well as other user data that can be used to generate customized responses and actions by the experience management system.

Additionally, the server(s) 702 include the composite agentic system 100. In one or more embodiments, the composite agentic system 100, via the server(s) 702, provides a personalized user experience for a third-party service. For instance, in some cases, the composite agentic system 100, via the server(s) 702, receives a user query. The composite agentic system 100 can determine tasks according to the user query, and utilize a knowledge graph to generate a user response customized to the user. The composite agentic system 100 can utilize the knowledge graph to complete the tasks from the user query in a way that is uniquely catered to the user. In some cases, via the server(s) 702, the composite agentic system 100 generates a user response to a user query according to a task item status received from an internal platform agent and/or a third-party agent platform 720. Additionally, in some embodiments, the composite agentic system 100 can include a multi-agent processing framework 708 (e.g., the multi-agent processing framework 106) that the composite agentic system 100 uses to orchestrate completion of discrete processing tasks.

Moreover, the environment 700 can include a third-party large language model 718. A third-party server can host the third-party large language model 718 for access by the composite agentic system 100. For example, the third-party large language model 718 can be external to the composite agentic system 100, but the composite agentic system 100 can nevertheless access and utilize the third-party large language model 718 via one or more plugins, APIs, or other network based protocols.

As illustrated, the environment 700 can include a third-party agent platform 720. A third-party server can host the third-party agent platform 720 for access by the composite agentic system 100. For example, the third-party agent platform 720 can be external to the composite agentic system 100, but the composite agentic system 100 can nevertheless access and utilize the third-party agent platform 720 via one or more plugins, APIs, or other network-based access protocols. For example, the third-party agent platform 720 can host one or more third-party agents for access by the composite agentic system 100 to use to complete discrete processing tasks associated with user queries.

Additionally, the environment 700 can include third-party services 722. A third-party server can host the third-party services 722 for access by the composite agentic system 100. For example, the third-party services 722 can be external to the composite agentic system 100, but the composite agentic system 100 can nevertheless access and utilize the third-party services 722 via one or more plugins, APIs, or other network-based access protocols.

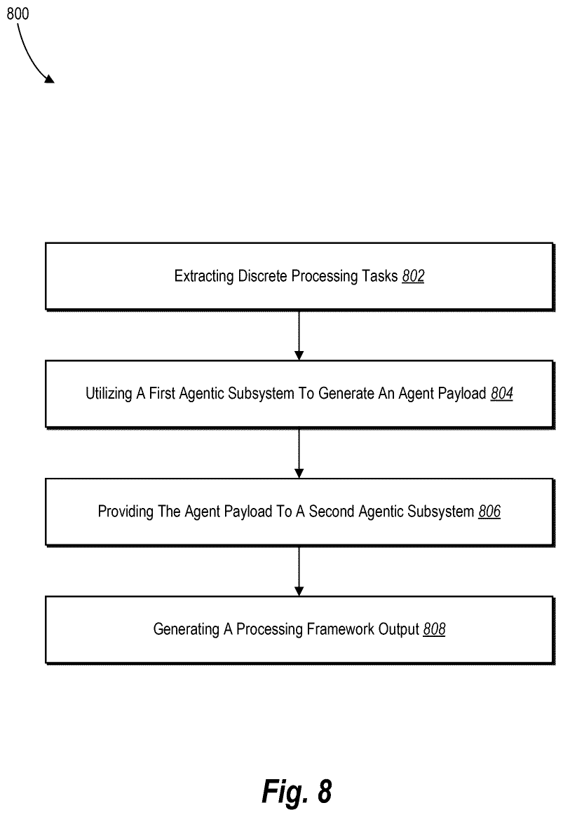

FIGS. 1-7, the corresponding text, and the examples provide a number of different methods, systems, devices, and non-transitory computer-readable media of the composite agentic system 100. In addition to the foregoing, one or more embodiments can also be described in terms of flowcharts comprising acts for accomplishing a particular result, as shown in FIG. 8. The method shown in FIG. 8 may be performed with more or fewer acts than shown. Further, the acts of FIG. 8 may be performed as shown. Additionally, the acts described herein may be repeated or performed in parallel with one or another or in parallel with different instances of the same or similar acts.

While FIG. 8 illustrates acts according to certain implementations, alternative implementations may omit, add to, reorder and/or modify any of the acts shown in FIG. 8. The acts of FIG. 8 can be performed as part of a computer-implemented method. Alternatively, a non-transitory computer-readable medium can comprise instructions (e.g., stored thereon) that, when implemented by one or more processors, cause a computing device to perform the acts of FIG. 8. In still further embodiments, a system can perform the acts of FIG. 8.

As illustrated in in FIG. 8, a series of acts 800 can include an act 802 of extracting discrete processing tasks. Specifically, the act 802 can include extracting, from a user query received from a client device, utilizing an orchestrator model of a multi-agent processing framework, discrete processing tasks for execution by respective agentic subsystems of the multi-agent processing framework. Additionally, the series of acts 800 can include an act 804 of utilizing a first agentic subsystem to generate an agent payload. Specifically, the act 804 can include executing, as instructed by the orchestrator model within the multi-agent processing framework, a first processing task of the discrete processing tasks utilizing a first agentic subsystem from among the respective agentic subsystems to generate an agent payload from the user query. Moreover, the series of acts 800 can include an act 806 of providing the agent payload to a second agentic subsystem. Specifically, the act 806 can include providing the agent payload from the first agentic subsystem to a second agentic subsystem from among the respective agentic subsystems by utilizing an agent-to-agent communication protocol. In addition, the series of acts 800 can include an act 808 of generating a processing framework output. Specifically, the act 808 can include generating, utilizing the second agentic subsystem to process the agent payload, a processing framework output resulting from the multi-agent processing framework.

In some embodiments, the first agentic subsystem belongs to a first subsystem classification and the second agentic subsystem belongs to a second subsystem classification.

Further, in one or more embodiments, the first subsystem classification includes a first set of subsystem types and the second subsystem classification includes a second set of subsystem types.

Additionally, in some embodiments, the series of acts 800 can include extracting, by a third agentic subsystem, a plurality of semantic encodings from a plurality of data items associated with a plurality of data streams. The series of acts 800 can further include determining, by utilizing a fourth agentic subsystem to process the plurality of semantic encodings, a data item from the plurality of data streams to surface to the client device.

Moreover, in one or more embodiments, the series of acts 800 can include generating the processing framework output by utilizing the second agentic subsystem to generate a notification of the data item determined from the plurality of semantic encodings.

Further, in some embodiments, the series of acts 800 can include providing the processing framework output from the multi-agent processing framework comprising the orchestrator model, the first agentic subsystem, and the second agentic subsystem, to a second multi-agent processing framework including a different orchestrator model and a different set of agentic subsystems. In addition, the series of acts 800 can include generating, utilizing the second multi-agent processing framework a second processing framework output to provide to the client device.

Furthermore, in one or more embodiments, the series of acts 800 can include identifying, utilizing the agent-to-agent communication protocol, a third agentic subsystem from among the respective agentic subsystems. Additionally, the series of acts 800 can include generating, utilizing the second agentic subsystem, an augmented agent payload to pass to the third agentic subsystem. Moreover, the series of acts 800 can include generating another processing chain output utilizing the third agentic subsystem to process the augmented agent payload.

Embodiments of the present disclosure can comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure can be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure can also be practiced in distributed system environments where local and remote computer systems, which are linked (either by hardwired data links, wireless data links, or by a combination of hardwired and wireless data links) through a network, both perform tasks. In a distributed system environment, program modules can be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of computing device 900 (e.g., the server(s) 702 and/or the client device 714) that can be configured to perform one or more of the processes described above. One will appreciate that one or more computing devices, such as the computing device 900, can implement the various devices of the environment of FIG. 7. As shown by FIG. 9, the computing device 900 can comprise a processor 902, a memory 904, a storage device 906, an I/O interface 908, and a communication interface 910, which can be communicatively coupled by way of a communication infrastructure 912. While a computing device 900 is shown in FIG. 9, the components illustrated in FIG. 9 are not intended to be limiting. Additional or alternative components can be used in other embodiments. Furthermore, in certain embodiments, the computing device 900 can include fewer components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions, the processor 902 can retrieve (or fetch) the instructions from an internal register, an internal cache, the memory 904, or the storage device 906 and decode and execute them. In one or more embodiments, the processor 902 can include one or more internal caches for data, instructions, or addresses. As an example, and not by way of limitation, the processor 902 can include one or more instruction caches, one or more data caches, and one or more translation lookaside buffers (TLBs). Instructions in the instruction caches can be copies of instructions in the memory 904 or the storage device 906.

The memory 904 can be used for storing data, metadata, and programs for execution by the processor(s). The memory 904 can include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 can be internal or distributed memory.

The storage device 906 includes storage for storing data or instructions. As an example, and not by way of limitation, storage device 906 can comprise a non-transitory storage medium described above. The storage device 906 can include a hard disk drive (HDD), a floppy disk drive, flash memory, an optical disc, a magneto-optical disc, magnetic tape, or a Universal Serial Bus (USB) drive or a combination of two or more of these. The storage device 906 can include removable or non-removable (or fixed) media, where appropriate. The storage device 906 can be internal or external to the computing device 900. In one or more embodiments, the storage device 906 is non-volatile, solid-state memory. In other embodiments, the storage device 906 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

The I/O interface 908 allows a user to provide input to, receive output from, and otherwise transfer data to and receive data from computing device 900. The I/O interface 908 can include a mouse, a keypad or a keyboard, a touch screen, a camera, an optical scanner, network interface, modem, other known I/O devices or a combination of such I/O interfaces. The I/O interface 908 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data can be representative of one or more graphical user interfaces and/or any other graphical content as can serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 can include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 910 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, the communication interface 910 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 910 can facilitate communications various communication protocols. Examples of communication protocols that can be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 912 can include hardware, software, or both that couples components of the computing device 900 to each other. As an example and not by way of limitation, the communication infrastructure 912 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 illustrates an example network environment 1000. Network environment 1000 includes a client system 1008, and an experience delivery system 1002 (e.g., the experience delivery system 704 of FIG. 7) connected to each other by a network 1004. Although FIG. 10 illustrates a particular arrangement of client system 1008, experience delivery system 1002, and network 1004, this disclosure contemplates any suitable arrangement of client system 1008, experience delivery system 1002, and network 1004. As an example, and not by way of limitation, two or more of client system 1008, and experience delivery system 1002 can be connected to each other directly, bypassing network 1004. As another example, two or more of client system 1008 and experience delivery system 1002 can be physically or logically co-located with each other in whole, or in part. Moreover, although FIG. 10 illustrates a particular number of client systems 1008, experience delivery system 1002, and network 1004, this disclosure contemplates any suitable number of client systems 1008, experience delivery system 1002, and network 1004. As an example, and not by way of limitation, network environment 1000 can include multiple client systems 1008, experience delivery system 1002, and network 1004.

This disclosure contemplates any suitable network 1004. As an example and not by way of limitation, one or more portions of network 1004 can include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1004 can include one or more networks.

Links can connect client system 1008, and experience delivery system 1002 to network 1004 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links can differ in one or more respects from one or more second links.

In particular embodiments, client system 1008 can be an electronic device including hardware, software, or embedded logic components or a combination of two or more such components and capable of carrying out the appropriate functionalities implemented or supported by client system 1008. As an example, and not by way of limitation, a client system 1008 can include any of the computing devices discussed above in relation to FIG. 10. A client system 1008 can enable a network user at client system 1008 to access network 1004. A client system 1008 can enable its user to communicate with other users at other client devices or systems.

In particular embodiments, client system 1008 can include a web browser, such as MICROSOFT EDGE, GOOGLE CHROME, or MOZILLA FIREFOX, and can have one or more add-ons, plug-ins, or other extensions, such as TOOLBAR or YAHOO TOOLBAR. A user at client system 1008 can enter a Uniform Resource Locator (URL) or other address directing the web browser to a particular server (such as server, or a server associated with a third-party system), and the web browser can generate a Hyper Text Transfer Protocol (HTTP) request and communicate the HTTP request to server. The server can accept the HTTP request and communicate to client system 1008 one or more Hyper Text Markup Language (HTML) files responsive to the HTTP request. Client system 1008 can render a webpage based on the HTML files from the server for presentation to the user. This disclosure contemplates any suitable webpage files. As an example, and not by way of limitation, webpages can render from HTML files, Extensible Hyper Text Markup Language (XHTML) files, or Extensible Markup Language (XML) files, according to particular needs. Such pages can also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser can use to render the webpage) and vice versa, where appropriate.

In particular embodiments, experience delivery system 1002 can include a variety of servers, sub-systems, programs, modules, logs, and data stores. In particular embodiments, experience delivery system 1002 can include one or more of the following: a web server, action logger, API-request server, relevance-and-ranking engine, content-object classifier, notification controller, action log, third party-content-object-exposure log, inference module, authorization/privacy server, search module, advertisement-targeting module, user-interface module, user-profile store, connection store, third-party content store, or location store. experience delivery system 1002 can also include suitable components such as network interfaces, security mechanisms, load balancers, failover servers, management-and-network-operations consoles, other suitable components, or any suitable combination thereof.

In particular embodiments, experience delivery system 1002 can include one or more user-profile stores for storing user profiles. A user profile can include, for example, biographic information, demographic information, behavioral information, social information, or other types of descriptive information, such as work experience, educational history, hobbies or preferences, interests, affinities, or location. Interest information can include interests related to one or more categories. Categories can be general or specific.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting, from a user query received from a client device, utilizing an orchestrator model of a multi-agent processing framework, discrete processing tasks for execution by respective agentic subsystems of the multi-agent processing framework;
executing, as instructed by the orchestrator model within the multi-agent processing framework, a first processing task of the discrete processing tasks utilizing a first agentic subsystem from among the respective agentic subsystems to generate an agent payload from the user query;
providing the agent payload from the first agentic subsystem to a second agentic subsystem from among the respective agentic subsystems by utilizing an agent-to-agent communication protocol; and
generating, utilizing the second agentic subsystem to process the agent payload, a processing framework output resulting from the multi-agent processing framework.

2. The computer-implemented method of claim 1, wherein the first agentic subsystem belongs to a first subsystem classification and the second agentic subsystem belongs to a second subsystem classification.

3. The computer-implemented method of claim 2, wherein:
the first subsystem classification comprises a first set of subsystem types; and
the second subsystem classification comprises a second set of subsystem types different from the first set of subsystem types.

4. The computer-implemented method of claim 1, further comprising:
extracting, by a third agentic subsystem, a plurality of semantic encodings from a plurality of data items associated with a plurality of data streams; and
determining, by utilizing a fourth agentic subsystem to process the plurality of semantic encodings, a data item from the plurality of data streams to surface to the client device.

5. The computer-implemented method of claim 4, wherein generating the processing framework output comprises utilizing the second agentic subsystem to generate a notification of the data item determined from the plurality of semantic encodings.

6. The computer-implemented method of claim 1, further comprising:
providing the processing framework output from the multi-agent processing framework comprising the orchestrator model, the first agentic subsystem, and the second agentic subsystem, to a second multi-agent processing framework comprising a different orchestrator model and a different set of agentic subsystems; and
generating, utilizing the second multi-agent processing framework a second processing framework output to provide to the client device.

7. The computer-implemented method of claim 1, further comprising:
identifying, utilizing the agent-to-agent communication protocol, a third agentic subsystem from among the respective agentic subsystems;
generating, utilizing the second agentic subsystem, an augmented agent payload to pass to the third agentic subsystem; and
generating another processing chain output utilizing the third agentic subsystem to process the augmented agent payload.

8. A system comprising:
at least one processor; and
at least one non-transitory computer-readable storage medium storing instructions that, when executed by the at least one processor, cause the system to:
extract, from a user query received from a client device, utilizing an orchestrator model of a multi-agent processing framework, discrete processing tasks for execution by respective agentic subsystems of the multi-agent processing framework;
execute, as instructed by the orchestrator model within the multi-agent processing framework, a first processing task of the discrete processing tasks utilizing a first agentic subsystem from among the respective agentic subsystems to generate an agent payload from the user query;
provide the agent payload from the first agentic subsystem to a second agentic subsystem from among the respective agentic subsystems by utilizing an agent-to-agent communication protocol; and
generate, utilizing the second agentic subsystem to process the agent payload, a processing framework output resulting from the multi-agent processing framework.

9. The system of claim 8, wherein the first agentic subsystem belongs to a first subsystem classification and the second agentic subsystem belongs to a second subsystem classification.

10. The system of claim 9, wherein the first subsystem classification comprises a first set of subsystem types; and
the second subsystem classification comprises a second set of subsystem types different from the first set of subsystem types.

11. The system of claim 8, further comprising instructions that, when executed by the at least one processor, cause the system to:
extract, by a third agentic subsystem, a plurality of semantic encodings from a plurality of data items associated with a plurality of data streams; and
determine, by utilizing a fourth agentic subsystem to process the plurality of semantic encodings, a data item from the plurality of data streams to surface to the client device.

12. The system of claim 11, further comprising instructions that, when executed by the at least one processor, cause the system to generate the processing framework output by utilizing the second agentic subsystem to generate a notification of the data item determined from the plurality of semantic encodings.

13. The system of claim 8, further comprising instructions that, when executed by the at least one processor, cause the system to:
provide the processing framework output from the multi-agent processing framework comprising the orchestrator model, the first agentic subsystem, and the second agentic subsystem, to a second multi-agent processing framework comprising a different orchestrator model and a different set of agentic subsystems; and
generate, utilizing the second multi-agent processing framework a second processing framework output to provide to the client device.

14. The system of claim 8, further comprising instructions that, when executed by the at least one processor, cause the system to:
identify utilizing the agent-to-agent communication protocol, a third agentic subsystem from among the respective agentic subsystems;
generate, utilizing the second agentic subsystem, an augmented agent payload to pass to the third agentic subsystem; and
generate another processing chain output utilizing the third agentic subsystem to process the augmented agent payload.

15. A non-transitory computer-readable medium storing instructions thereon that, when executed by at least one processor, cause a computing device to:
extract, from a user query received from a client device, utilizing an orchestrator model of a multi-agent processing framework, discrete processing tasks for execution by respective agentic subsystems of the multi-agent processing framework;
execute, as instructed by the orchestrator model within the multi-agent processing framework, a first processing task of the discrete processing tasks utilizing a first agentic subsystem from among the respective agentic subsystems to generate an agent payload from the user query;
provide the agent payload from the first agentic subsystem to a second agentic subsystem from among the respective agentic subsystems by utilizing an agent-to-agent communication protocol; and
generate, utilizing the second agentic subsystem to process the agent payload, a processing framework output resulting from the multi-agent processing framework.

16. The non-transitory computer-readable medium of claim 15,, wherein the first agentic subsystem belongs to a first subsystem classification and the second agentic subsystem belongs to a second subsystem classification.

17. The non-transitory computer-readable medium of claim 16, wherein the first subsystem classification comprises a first set of subsystem types; and
the second subsystem classification comprises a second set of subsystem types different from the first set of subsystem types.

18. The non-transitory computer-readable medium of claim 15, further comprising instructions that, when executed by the at least one processor, cause the computing device to:
extract, by a third agentic subsystem, a plurality of semantic encodings from a plurality of data items associated with a plurality of data streams; and
determine, by utilizing a fourth agentic subsystem to process the plurality of semantic encodings, a data item from the plurality of data streams to surface to the client device.

19. The non-transitory computer-readable medium of claim 18, further comprising instructions that, when executed by the at least one processor, cause the computing device to generate the processing framework output by utilizing the second agentic subsystem to generate a notification of the data item determined from the plurality of semantic encodings.

20. The non-transitory computer-readable medium of claim 15, further comprising instructions that, when executed by the at least one processor, cause the computing device to:
provide the processing framework output from the multi-agent processing framework comprising the orchestrator model, the first agentic subsystem, and the second agentic subsystem, to a second multi-agent processing framework comprising a different orchestrator model and a different set of agentic subsystems; and
generate, utilizing the second multi-agent processing framework a second processing framework output to provide to the client device.
